(19) United States
(12) Patent Application Publication
(10) Pub. No.: US 2025/0079586 A1
(43) Pub. Date: Mar. 6, 2025

(54) LID CLOSURE FOR A SECONDARY CELL

(71) Applicant: NORTHVOLT AB, Stockholm (SE)

(72) Inventor: Santhosh SADHASIVAM, Västerås (SE)

(21) Appl. No.: 18/800,317

(22) Filed: Aug. 12, 2024

(30) Foreign Application Priority Data
Aug. 31, 2023 (SE) 2351027-4

(51) Int. Cl. H01M 50/152; H01M 10/04; H01M 50/107; H01M 50/169; H01M 50/188; H01M 50/249

(52) U.S. Cl. CPC H01M 50/152; H01M 10/0422; H01M 10/0431; H01M 50/107; H01M 50/169; H01M 50/188; H01M 50/249

(57) ABSTRACT

There is disclosed herein a cylindrical secondary cell (100), a method (6000) of manufacturing the secondary cell (100), and a lid (130) for the secondary cell (100). The secondary cell (100) comprises a cylindrical can (107) housing an electrode assembly (106), the cylindrical can (107) having an open end (107b) and a lid (130) configured to close the open end (107b) of the cylindrical can (107). According to particularly advantageous aspects of the present disclosure, the lid (130) comprises a clamping portion (111) configured to clamp around an edge (107e) of the open end (107b) of the cylindrical can (107) to thereby close the open end (107b) of the cylindrical can (107), rather than the can itself comprising a clamping portion to clamp around the lid.

### BACKGROUND

### Related Field

The present disclosure relates to a terminal assembly for a secondary cell, a secondary cell comprising the terminal assembly, and a method of manufacturing such a secondary cell.

### Related Art

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### BRIEF SUMMARY

The present disclosure aims to provide improved secondary cells and parts thereof. The improvements may be in energy performance, manufacturing efficiency, decreased amount of material used, and assembly simplification, among others.

A first aspect of the present disclosure relates to a cylindrical secondary cell comprising a cylindrical can (or ‘casing’) that houses an electrode assembly (or ‘electrode roll’ or ‘jelly roll’), the cylindrical can having an open end for closing by a lid. A second aspect of the present disclosure relates to a method for manufacturing such a cylindrical secondary cell, and a third aspect of the present disclosure relates to the lid as such. A fourth aspect of the present disclosure relates to a battery pack comprising a plurality of secondary cells, which may be adapted for use in automotive applications, such as an electric or hybrid vehicle. A fifth aspect thus relates to an electric or hybrid vehicle comprising a battery pack according to the fourth aspect.

According to aspects of the present disclosure, there is provided a lid configured to close an open end of a cylindrical can, wherein the lid comprises a clamping portion configured to clamp around an edge of the open end of the cylindrical can to thereby close the open end of the cylindrical can.

Conventional means for closing a can may comprise forming a beading groove in a side wall of the can, arranging a gasket around a lid, and placing said lid, with the gasket arranged therearound, upon the surface formed by the beading groove. The top lip of the can may then be folded over the lid and the gasket therearound to form a clamping portion between the beading groove and the folded top lip of the can. The clamping portion may then be clamped to thereby seal the can. Thus, put concisely, prior art approaches to closing a cylindrical can comprise forming a clamping portion in the can.

By clear contrast, aspects of the present disclosure pertain to the forming of a clamping portion in the lid. In this way, the lid is clamped to the can rather than the can to the lid, and hence a greater internal volume of the can may be utilized for housing the electrode assembly, instead of forming a clamping portion for the lid, which further includes the axial extension of the gasket around the lid. Hence, the overall energy density of the cell can be improved.

There are a number of optional refinements that could be employed when implementing aspects of the present disclosure. For example, a gasket may be arranged in the clamping portion and configured to seal the cylindrical can when the clamping portion of the lid is clamped therearound.

The use of a gasket in a clamping portion is well understood as being a reliable means for sealing a cell in a satisfactorily fluid-tight (preferable hermetic) manner. The gasket may be arranged in the clamping portion before arrangement thereof around the edge of the open end of the can, or the gasket may be arranged around the edge of the open end of the can before arrangement of the clamping portion therearound. The gasket may surround all sides of the edge of the can (internal, external, and the extension of the thickness of the can therebetween), or the gasket may only cover one or two of said sides, depending on the implementation. Moreover, the gasket may be preferably formed of a compressible material that is resistant to heat and corrosion, such as a PPS polymer, PBT, or the like. However, the particulars of the gasket are not the focus of the present disclosure.

The lid may optionally form an electrical connection with the electrode assembly. In such cases, the lid may further form an optional electrical connection with the casing, e.g., via a direct or indirect connection thereto.

For example, the lid may act as a current collector, in that the lid may comprise one or more recessed contact portions configured to form a direct electrical contact with the electrode assembly and, in such cases, the lid may be in direct electrical contact with the cylindrical can.

Hence, an electrical connection between the electrode assembly (e.g., the anode side thereof) and the casing can be formed. The casing, being preferably formed of a conductive material such as a metal like nickel-plated steel or aluminum, may then act as an electrical terminal for the cell (e.g., the negative terminal). Advantageously, it is not required, in such examples, to provide an additional current collector into the cell. Thus, the number of components and process steps required to manufacture the cell, and a greater internal volume of the cell can be occupied by the electrode assembly, thereby improving the energy density of the cell.

If the lid is placed into electrical connection with the can, then at least the clamping portion of the lid may be placed in direct electrical contact with the cylindrical can. Hence, the secure mechanical connection formed by the clamping portion around the edge of the bottom end of the can may further serve as an electrical connection. Thus, it may not be required to perform separate steps to mechanically and electrically connect the lid to the can, thereby further improving the efficiency of the manufacture of the cell.

In some examples, the cell may further comprise a current collector in direct electrical contact with the electrode assembly, and configured to form an electrical connection with the cylindrical can and/or the lid. That is, the current collector may only form an electrical connection between the electrode assembly and the can, without additionally connecting to the lid or connecting to the can via the lid. Alternatively, the current collector may only form an electrical connection between the electrode assembly and the lid, and the lid may only optionally be further electrically connected to the can.

A separate current collector may provide greater design freedom to the lid, and may improve current flow within the cell. The current collector may be a disc, a plate, a ring, or have some other shape, depending on the desired properties of the current collector. The particulars of the design of the current collector are not the focus of the present disclosure.

The orientation of the clamping portion can be defined by the plane along which the clamping occurs. For example, the edge of the open end of the cylindrical can may comprise a flange extending radially outwards from a side wall of the can (preferably at 90 degrees) and the clamping portion may thus be non-parallel to the axial extension of the can.

In this way, a greater scaling surface can be presented to the internal volume of the can, and thereby a greater seal of the can may be achieved. The can is preferably sealed in a manner that is hermetic, or at least fluid-tight.

The clamping portion and the edge (formed as a flange) of the can may thus radially protrude from the side wall of the can by some amount. To at least partially compensate for such a radial extension, a side wall of the cylindrical can adjacent to the edge of the open end of the cylindrical can may comprises a radially reduced section and, in preferred examples, the radial reduction of the cylindrical can in the radially reduced section is substantially equal to the radial extension of the flange.

In order to advantageously maximize a radius of the electrode roll in the cell, and thus the energy density of the cell, the radially reduced section may be beyond the axial extent of the electrode assembly. Thus, the reduction in radius of the casing may not impact the size of the electrode roll that can be installed into the cell. For example, the reduced radius section may be formed as a shelf or groove above the electrode assembly. Such a shelf or groove or shelf may be formed after insertion of the electrode assembly and may further act to hold the electrode assembly in place in the cell (at least in an axial direction).

However, viewed from another perspective, embodiments of the present disclosure that do not require a radial reduction, or any modification, to the can may advantageously reduce the number of process steps required to manufacture the cell. Moreover, the process steps in manufacturing the cell may be advantageously decoupled in this way, as the lid can be provided pre-shaped, and the electrode roll can be introduced at another stage, not being dependent upon when a shaping or narrowing of the can is undertaken.

Generally speaking, a method of manufacturing the cylindrical secondary cell according to aspects of the present disclosure comprises arranging the clamping portion of the lid around the edge of the open end of the cylindrical can, and clamping the clamping portion around the edge of the open end of the cylindrical can to thereby close the open end of the cylindrical can.

The lid may be pre-shaped to have the clamping portion, or the clamping portion may be formed in the lid when the lid is arranged against the can, depending on the implementation. That is, arranging the clamping portion around the edge of the open end of the cylindrical can may comprise shaping or forming the clamping portion around the edge of the open end of the cylindrical can.

In embodiments of the cell that comprise a gasket, the method further comprises arranging a gasket in the clamping portion such that clamping the clamping portion around the edge of the open end of the cylindrical can and the gasket seals the cylindrical can.

In other embodiments, where a gasket may not be compatible with welding, or where welding may suitably replace a gasket in respect of the seal provided to the can, the method may further comprise welding the clamping portion of the lid to the cylindrical can. Welding may comprise laser welding, resistance welding, ultrasonic welding, soldering, or the like.

Clamping of the clamping portion around the edge of the open end of the cylindrical can and the welding of the clamping portion of the lid to the cylindrical can may preferably be performed simultaneously. That is, a tool may be designed that can both apply pressure and welding energy (e.g., heat) so as to clamp the clamping portion and seal it with a weld.

It will be appreciated that the lid may be provided as a separate part for fitting onto and thereby closing an open end of cylindrical secondary cells. Such a lid comprises a main body substantially formed as a disc and a clamping portion configured to clamp around an edge of a cylindrical casing for the secondary cell. It will be appreciated that the lid may be further adapted for use in a cylindrical secondary cell according to those described herein.

The clamping portion may be pre-formed in such a way as to be configured to receive or at least be clamped around an edge of a can of a cylindrical secondary cell. For example, the clamping portion may have at least two surfaces substantially facing each other, with a space in between for receiving an edge of the can, such that a clamping tool can be arranged around said surfaces and clamp them towards each other to thereby clamp said surfaces of the clamping portion around the end of the can.

In preferred examples, the lid may be formed, preferably from (sheet) metal such as nickel-plated steel or aluminum, by stamping or punching a disc-shaped (circular) metal blank, but further processing steps may be performed to effectively form the clamping portion.

### BRIEF DESCRIPTION OF THE FIGURES

One or more embodiments of the present disclosure will be described, by way of example only, and with reference to the following figures, in which:

FIG. 1 schematically shows a cross-sectional view of a cylindrical secondary cell having a lid closure according to an example implementation of aspects of the present disclosure;

FIG. 2 schematically shows a partial cross-sectional view of a cylindrical secondary cell having a lid closure according to another example implementation of aspects of the present disclosure;

FIG. 3 schematically shows a partial cross-sectional view of a cylindrical secondary cell having a lid closure according to yet another example implementation of aspects of the present disclosure;

FIG. 4 schematically shows a partial cross-sectional view of a cylindrical secondary cell having a lid closure according to a further example implementation of aspects of the present disclosure;

FIG. 5 schematically shows a partial cross-sectional view of a cylindrical secondary cell having a lid closure according to a still further example implementation of aspects of the present disclosure;

FIG. 6 illustrates a method of manufacturing a cylindrical cell according to aspects of the present disclosure;

FIG. 7 schematically shows a face-on view of a lid for a cylindrical secondary cell according to aspects of the present disclosure;

FIG. 8 schematically shows a perspective view of a battery pack comprising secondary cells according to aspects of the present disclosure; and

FIG. 9 schematically shows a vehicle comprising the battery pack of FIG. 8.

### DETAILED DESCRIPTION OF VARIOUS EMBODIMENTS

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

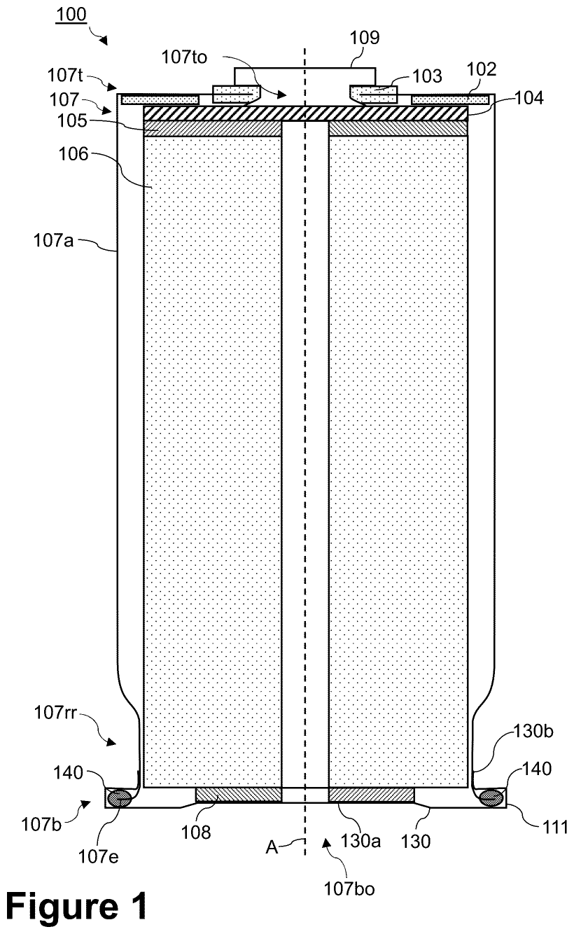

FIG. 1 schematically shows a cross-sectional view of a cylindrical secondary cell 100 (which may also be referred to as ‘battery cell 100’ or simply ‘cell 100’) comprising a lid 120 in a bottom opening 170bo of a cylindrical casing 107. The cell 100 comprises an electrode roll 106 housed in the cylindrical casing 107.

The cylindrical casing 107 (which may also be referred to as ‘can 107’) extends along an axis A between a first end 107t, which may be referred to as a ‘top end’ 107t, and an open bottom end 107b which is closed by a lid 130. As used here, the terms ‘top’ and ‘bottom’ are merely labels to assist in a distinction between ends of the casing 107-it will be appreciated that the cell 100 may have no preferred or fixed orientation in use.

The casing 107 further comprises a curved side wall 107a having a reduced radius section 107rr towards the bottom end 107b. A lip is formed at the edge 107e of the bottom end 107b of the casing 107e, the lip being formed as a flange extending radially outwards from the side wall 107a.

The lid 130 comprises a clamping portion 111 that is arranged around the edge 107e of the casing 107, wherein a gasket 140 is arranged around the edge 107e of the can 107 at the clamping portion 111 to thereby seal the bottom end opening 107bo of the casing 107. It will be appreciated that the clamping portion 111 is formed through the provision of at least a pair of surfaces on the lid 130 that are substantially facing each other on either side of a space configured to receive the edge 107e of the bottom end 107b of the casing 107.

The reduced radius portion 107rr of the can 107 is a portion towards the bottom end 107b of the cylindrical can 107 whose radius is reduced relative to a portion towards the top end 107t of the can 107. The reduction in radius is shown in FIG. 1 as being smooth so as to form a curved transition region, but in other examples, the transition may be more sudden and the reduced radius portion 107rr more discrete from the rest of the can 107.

By providing the reduced radius portion 107rr, an overall radius of the can 107 can be kept within a prescribed limit, while allowing for the radial extension of the lip at the edge 107e of the bottom end 107b of the can 107. In a preferred example, the radial extension of the lip (formed as a flange) at the edge 107e of the bottom end 107b of the can 107 is substantially equal to the radial reduction of the radially reduced section 107rr of the can 107. In this way, the reduced radius section 107rr is only reduced enough to accommodate the lip, without excessively limiting the size of the electrode roll 106.

The electrode roll 106 may be formed of an anode sheet, a cathode sheet, and a separator sheet arranged therebetween to thereby enable a storage of electrical energy. Cathode tabs 105 may extend from a first end of the electrode roll 106 and anode tabs 108 may extend from the other end, or vice versa. The cathode tabs 105 and anode tabs 108 may provide connective surfaces to which a current collecting plate 104 or a recessed portion 130a of the lid 130 can be connected or placed in direct abutment with. The battery cell further comprises a rivet 109 extending through an opening 107to in the casing 107.

A cathode current collector 104, which in some examples is or comprises a current collector plate, is arranged in direct electrical contact with the cathode tabs 105 and the lid 130 is arranged in direct electrical contact with the anode tabs 108 by virtue of the recessed contact portion 130a. Here, the labels ‘cathode’ and ‘anode’ may be swapped. Thus, an electrical connection is formed from the cathode tabs 105 to the rivet 109, as the rivet 109 is connected to the current collecting plate 104. The rivet 109 is insulated from the can 107 by a terminal gasket 103, which also seals a top opening 107to of the can 107. The current collector 104 is insulated from the can by an insulator 102 arranged on an inner flat surface at the top section 107t of the can 109.

An electrical connection is also formed from the anode tabs 108 to the casing 107 via the lid 130, as the lid 130 further comprises a can connection portion 130b, being beyond the clamping portion 111 in this example. The connection of the lid 130 directly to the anode tabs 108 advantageously allows for a reduction in parts and process steps in manufacture of the cell 100, as it is not required to provide an anode current collector. Moreover, the connection of the lid 130 to the can at the connection portion 130b, being exposed on the outer surface of the can 107, allows for an case of inspection of said connection (e.g., a welded connection).

Thus, it can be seen that the exposed head of the terminal rivet 109 serves as an external terminal of the cell 100, this being a positive terminal in this example, and the casing 107 and the lid 130 serves as the negative terminal. Hence, it is seen that both terminals of the cell 100 are accessible at the same side, albeit insulated from each other (i.e., by the gasket 103). The top end 107t of the casing 107 comprises a first electrical contact surface extending in a first plane, and the head of the rivet 109 comprises a second electrical contact surface, extending in a second plane axially spaced from the first plane.

This electrical configuration of the cell 100 is purely an example, and details of the top part 107t of the casing 107, including the rivet 109 and associated components are not the focus of the present disclosure. Indeed, the terminal rivet 109 may be replaced by another terminal assembly, which may not be formed as a rivet.

Further examples of the closing of the bottom portion 107b of the cylindrical can 107 using a lid 130 will now be described.

The clamping portion 111 of the lid 130 is arranged so as to form a watertight seal of the cylindrical can 107. The watertight seal prevents any liquid, such as a liquid electrolyte, from exiting the can 107 at the bottom end 107b through the bottom end opening 107bo. It will be appreciated that the lid 130 may, in some examples, comprise a failure vent for venting gases upon, e.g., failure of the cell and a thermal runaway event, and/or an injection port or similar through-hole for the introduction of a liquid electrolyte. Such a through-hole is preferably closeable and sealable from the outside, e.g., using a blind rivet or the like.

The lid 130 may be further arranged to form an electrical connection from the electrode roll 106 to the cylindrical can 107, e.g., by electrical contact of the lid 130 with the can at the clamping portion 111 or elsewhere. As the lid 130 is in direct contact with the current collector or the electrode tabs in such examples, the lid forms part of the negative terminal of the cell 100 in these examples. In the example shown in FIG. 1, the lid 130 is arranged in direct contact with the can 107 at a connection portion 130b, as discussed above.

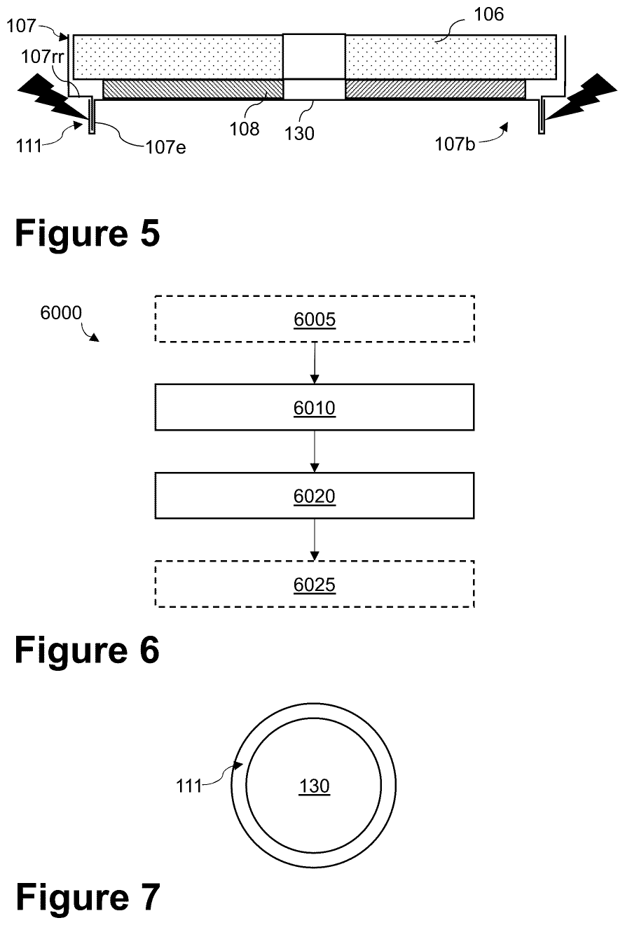

The watertight seal may be achieved by, for example, the use of a gasket 140 to seal the opening between the lid 130 and the can 107, and/or by welding the lid 130 to the can 107 (e.g., at the clamping portion 111 or elsewhere), as discussed more in relation to FIG. 5. When the lid 130 is welded to the can 107, the use of a gasket 140 is optional.

In the example shown in FIG. 1, the can 107 is closed by a lid 130 and a gasket 140, where the clamping portion 111 of the lid 130 is arranged around the edge 107e of the bottom end 107b of the can 107. The edge 107e of the can 107, the clamping portion 111 of the lid 130, and the gasket 140 may be clamped or compressed together so as to form the watertight seal.

As described above, the gasket 140 may, when clamped with the lid 130 at the clamping portion 111, form a watertight seal. In some examples, the gasket 140 may further act so as to electrically isolate the lid 130 from the can 107.

The gasket 140 may be formed of a polymer having elastic, resilient, and electrically insulating properties, such as PFA, PBT, PPS, or the like, or some combination thereof.

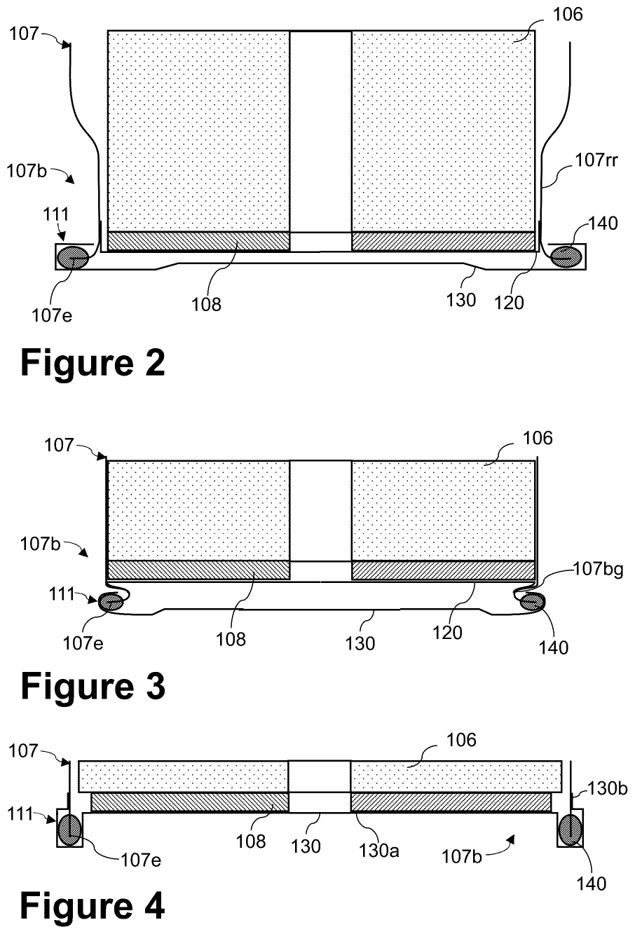

More configurations of the bottom portion 107b of the can are described with reference to FIGS. 2 to 5, wherein the cell 100 comprises a lid 130 with a clamping portion 111 according to aspects of the present disclosure. The reference numerals used in FIG. 1 are re-used in later figures where the components are the same or similar at least in respect of one or more of their functions.

The lid closure shown in FIG. 2 differs from that shown in FIG. 1 primarily in that the cell further comprises a current collector 120 in direct electrical contact with the electrode tabs/foils 108. The current collector 120 forms a current path from the electrode roll 106 to the can 107 via a flange arranged around the edge of the current collector 120, extending axially towards the top of the can 107. Hence, in this example, the lid 130 does not comprise a connection portion 107b as opposed to the cell shown in FIG. 1.

Hence, in this example, the lid 130 is not electrically connected to the electrode assembly. In a variation, the current collector 120 may connect to the lid 130, and the lid 130 may then be connected to the can 107. Alternatively, it may not be required that the can 107 is connected to the electrode roll 106 at all, such that only the lid 130 acts as the negative terminal.

Although the gasket 140 is shown as surrounding the edge 107e of the can 107, it will be appreciated that the gasket 140 may instead only be arranged on side of the edge 107e of the can 107, such that an electrical connection can be formed between the edge 107e of the can 107 and the clamping portion 111 of the lid 130.

FIG. 3 shows an alternative configuration of a lid closer for a bottom part 107b of a casing, wherein the casing 107 comprises a beading groove 107bg substantially at the axial end of the casing 107, i.e., without any additional continuation of the curved side wall 107a beyond the beading groove 107bg.

As with the example shown in FIG. 2, the cell comprises a current collector 120. In this example shown in FIG. 3, the current collector 120 comprises a flange extending axially away from the electrode roll 106, wherein the flange is bent down and towards the electrode roll 106 by the beading groove 107bg such that the current collector 120 is clamped and secured between the beading groove 107bg and the electrode roll 106.

In this way, the electrode roll 106 and the current collector 120 can be secured in place in the casing 107 without requiring further process steps beyond the formation of the beading groove 107bg.

Again, the lid 130 comprises a clamping portion 111 arranged around the edge 107e of the bottom portion 107b of the casing 107. Hence, it can be seen that the clamping portion 111 of the lid 130 at least partially axially overlaps with the beading groove 107bg. Hence, according to such an arrangement, and with contrast to prior art implementations of a beading groove, the axial distance required to form the lid closure is less, and thus a greater internal volume of the cell can be provided for expanding the size of the electrode assembly 106, thereby improving the energy density of the cell.

FIG. 4 schematically shows another example embodiment, wherein the can 107 has no reduced radial section or beading groove or any modification. Indeed, it can be seen in FIG. 4 that the cylindrical can 107 has not been modified from a straight axial extension with a constant radius.

In this example, the clamping portion 111 of the lid 130 has a perpendicular orientation relative to the examples shown in FIGS. 1 to 3. That is, the clamping portion 111 is aligned along the axial extension of the can 107. The protrusion formed by the clamping portion 111 may advantageously provide an area to grip the cell.

In this example, the lid 130 may not require recessed contact portions as the electrode assembly 106 may be able to axially extend such that the exposed electrode tabs 108 contact a flat surface 130a of the lid 130. Hence, an enhanced energy density of the cell may be achieved.

The lid 130 is electrically connected to the can 107 via an outer connection portion 130b, similarly as with the example shown in FIG. 1.

The example shown in FIG. 5 is similar to that shown in FIG. 4 in respect of having a clamping portion 111 aligned along the axial extension of the cell. However, a part of the side wall of the casing 107 adjacent the edge 107e of the bottom end 107b of the casing 107 comprises a reduced radius section 107rr in the form of a shelf that is axially spaced from the electrode assembly 106 so as not to place any radial constraints thereon.

The edge 107e of bottom end 107b of the casing is forms as an extension in the axial direction so as to be surrounded by the clamping portion 111 of the lid 130 that extends in the same direction.

By contrast to the example shown in FIG. 4, however, the clamping portion 111 does not comprise a gasket. Instead, the clamping portion is welded to the edge 107e of the casing 107. By welding in this way, both surfaces of the clamping portion can be attached to the edge 107e of the casing 107, thereby forming an enhanced seal relative to if, e.g., only one surface were welded to the edge 107e of the casing 107.

FIG. 6 illustrates a method 6000 of manufacturing a secondary cell, such as any of those described above. The method 6000 comprises arranging 6010 the clamping portion of the lid around the edge of the open end of the cylindrical can, and clamping 6020 the clamping portion around the edge of the open end of the cylindrical can to thereby close the open end of the cylindrical can.

Optionally, the method 6005 comprises, as a step before said steps, arranging 6005 a gasket in the clamping portion such that clamping the clamping portion around the edge of the open end of the cylindrical can and the gasket seals the cylindrical can. The gasket may be arranged in the clamping portion before the clamping portion is introduced around the edge of the can, or the gasket may be arranged on the edge of the can such that arranging the clamping portion around the edge of the can comprises arranged the clamping portion around the gasket.

Further optionally, the method 6000 comprises welding 6025 the clamping portion of the lid to the cylindrical can. This step of welding 6025 may be performed after the step of clamping 6020 the clamping portion, or substantially simultaneously therewith. For example, the clamping 6020 may be performed by a tool that is configured to both clamp and weld, which may advantageously reduce the number of process steps required in the method 6000.

It will be appreciated that the method 6000 is clearly a subset of all of the steps that may be undertaken in manufacturing a secondary cell, but these further additional steps are not the focus of the present disclosure.

FIG. 7 schematically shows a face-on view of a lid 130 according to aspects of the present disclosure. According to the example shown in FIG. 7, the lid 130 is circular and comprises a central main body and a clamping portion 111 arranged around the main body. In this example, the clamping portion 111 is at a periphery of the lid 130. However, it will be appreciated that the clamping portion 111 may be arranged at some intermediate radius of the circular lid 130.

In preferred examples, the clamping portion 111 extends entirely around the lid 130 so as to form an annular shape (at least in this view), such that the clamping portion 111 can clamp around all of the edge of the bottom end of the can to form a complete seal.

The lid 130 is preferably formed of metal, such as nickel-plated steel or aluminum, and may be formed by pressing or stamping (sheet) metal into a desired shape, with some optional further processing.

Although the lid 130 is shown without much detail, it will be appreciated that the lid 130 may further comprise shaped protrusions and/or recesses. For example, the lid 130 may comprise recessed contact portions for electrically contacting the exposed tabs of the electrode assembly, protruding vent parts for venting gases during, e.g., a failure of the cell, a through-hole for injecting electrolyte and configured to be closed from the outside by, e.g., a blind rivet, or other features, the particulars of which are not the focus of the present disclosure.

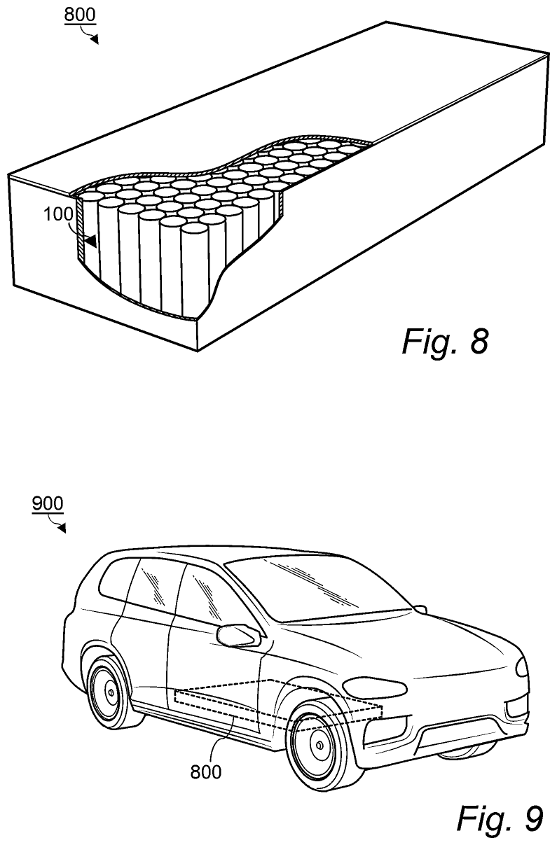

FIG. 8 shows a perspective view of a battery pack 800 with a portion of its casing (being illustrated in a purely schematic way) cut away to schematically show a plurality of secondary cells 100 housed therein. The secondary cells 100 may correspond to the secondary cells 100 described above.

The secondary cells 100 are connected together in series and/or parallel, and in an optionally modular fashion, so as to form a combined electrical storage capacity. In some examples, the cells have a common orientation such that failure vents of the cells are oriented in a same direction, and such that the terminals of the cells (which may be on the same side, as discussed in relation to FIG. 1) can be accessed at a same side.

FIG. 9 schematically shows an example vehicle 900 comprising the battery pack 800 shown in FIG. 8. In this example, the battery pack is arranged at a lower portion of the vehicle 900, which may be an electric or hybrid vehicle. Other uses for the battery pack 800 may comprise a standalone battery pack for powering devices or installations or the like.

It will be appreciated that the advantages described above in respect of, e.g., energy density, conferred to the secondary cells according to aspects of the present disclosure, will also be conferred to a battery pack comprising said cells, and any vehicle comprise such a battery pack. Thus, these advantages are not discussed in detail again.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1-15. (canceled)

16. A cylindrical secondary cell comprising:
a cylindrical can housing an electrode assembly, the cylindrical can having an open end; and
a lid configured to close the open end of the cylindrical can;
wherein the lid comprises a clamping portion configured to clamp around an edge of the open end of the cylindrical can to thereby close the open end of the cylindrical can.

17. The cylindrical secondary cell according to claim 16, further comprising a gasket arranged in the clamping portion and configured to seal the cylindrical can when the clamping portion of the lid is clamped therearound.

18. The cylindrical secondary cell according to claim 17, wherein the lid comprises one or more recessed contact portions configured to form a direct electrical contact with the electrode assembly, and the lid is in direct electrical contact with the cylindrical can.

19. The cylindrical secondary cell according to claim 16, wherein the lid comprises one or more recessed contact portions configured to form a direct electrical contact with the electrode assembly, and the lid is in direct electrical contact with the cylindrical can.

20. The cylindrical secondary cell according to claim 19, wherein at least the clamping portion of the lid is in direct electrical contact with the cylindrical can.

21. The cylindrical secondary cell according to claim 16, further comprises a current collector in direct electrical contact with the electrode assembly, and configured to form an electrical connection with the cylindrical can and/or the lid.

22. The cylindrical secondary cell according to claim 16, wherein the edge of the open end of the cylindrical can comprises a flange extending radially outwards from a side wall of the can.

23. The cylindrical secondary cell according to claim 16, wherein a side wall of the cylindrical can adjacent to the edge of the open end of the cylindrical can comprises a radially reduced section.

24. The cylindrical secondary cell according to claim 23, wherein the radially reduced section is beyond the axial extent of the electrode assembly.

25. The cylindrical secondary cell according to claim 23, wherein the radial reduction of the cylindrical can in the radially reduced section is substantially equal to the radial extension of the flange.

26. The cylindrical secondary cell according to claim 22, wherein the radial reduction of the cylindrical can in the radially reduced section is substantially equal to the radial extension of the flange.

27. A method of manufacturing the cylindrical secondary cell of claim 16, comprising:
arranging the clamping portion of the lid around the edge of the open end of the cylindrical can; and
clamping the clamping portion around the edge of the open end of the cylindrical can to thereby close the open end of the cylindrical can.

28. The method according to claim 27, further comprising:
arranging a gasket in the clamping portion such that clamping the clamping portion around the edge of the open end of the cylindrical can and the gasket seals the cylindrical can.

29. The method according to claim 27, further comprising:
welding the clamping portion of the lid to the cylindrical can.

30. The method according to claim 29, wherein the clamping of the clamping portion around the edge of the open end of the cylindrical can and the welding of the clamping portion of the lid to the cylindrical can are performed simultaneously.

31. A lid for a cylindrical secondary cell, comprising:
a main body substantially formed as a disc; and
a clamping portion configured to clamp around an edge of a cylindrical casing for the secondary cell.

32. The lid according to claim 31, wherein the lid is configured for use in a cylindrical secondary cell comprising a cylindrical can housing an electrode assembly, the cylindrical can having an open end, and a lid configured to close the open end of the cylindrical can, wherein the lid comprises a clamping portion configured to clamp around an edge of the open end of the cylindrical can to thereby close the open end of the cylindrical can.
